(19) United States
(12) Patent Application Publication
(10) Pub. No.: US 2019/0146807 A1
(43) Pub. Date: May 16, 2019

(54) ESTABLISHING AN EVENT-BASED SESSION BETWEEN A USER DEVICE AND AN AGENT DEVICE

(71) Applicant: Renew.com Inc., Dover, DE (US)

(72) Inventors: Anthony Michael DeGangi, Los Angeles, CA (US); Douglas Michael Carney, Los Angeles, CA (US)

(21) Appl. No.: 15/812,643

(22) Filed: Nov. 14, 2017

(51) Int. Cl. G06F 9/44; G06F 17/22; H04L 29/08

(52) U.S. Cl. CPC G06F 9/4446; G06F 17/2288; H04L 67/42; H04L 67/32; H04L 67/146; G06F 17/2205

(57) ABSTRACT

An online system allows a web page user to establish a session with an agent that allows the agent to view and interact with a web page provided to the user. The online system transmits a session identifier to the user, which the user provides to an agent of the online system to connect to the user's session. Both the user and the agent can view and interact with the web page. The user's interactions with the web page are communicated to the agent's device through page events and the agent's interactions with the web page are communicated to the user's device through requests for page events. The page events can be used to play back the session in the future without capturing video data.

### BACKGROUND

Online systems provide web pages so that users can access services provided by the online system. At times, users may have questions about aspects of the services provided by the online system or may have technical issues with a web page. However, conventional online systems typically do not provide effective real-time assistance to users. Audio channels and real-time text-based chat features require the user to describe the state of the web page, which can be burdensome and inaccurate. Capturing a user's screen in a video stream can be used, however this approach requires a significant amount of bandwidth and memory to transmit and store the video data.

### SUMMARY

An online system allows a web page user to establish a session with an agent that allows the agent to view and interact with a web page provided to the user. A user uses a client device to connect to a web content server and request a web page from the web content server. The web content server transmits the requested web page to the user's client device and the user can interact with the web page. If the user needs assistance from an agent, the user can transmit a request for assistance to an assistance server of an online system. The assistance server generates a session identifier and transmits the session identifier to the user. The session identifier identifies a session through which an agent can view and interact with the user's web page. The user provides the session identifier to the agent via a channel that is out-of-band channel established between a user client device and an agent device. The out-of-band channel can include an audio channel or a text-based channel. For example, the out-of-band channel can include a telephone call, an online audio conversation, or an online text-based conversation.

The agent provides the assistance server with the session identifier and is connected to the user's session. The user's client device transmits a state of the web page to the agent's device via the assistance server. The state of the web page reflects changes to the state of the web page that have occurred before starting the session. For example, the original page state can include options that the user has selected or text that the user has input to text fields before the session began. In some embodiments, the assistance server stores the state of the web page and transmits the web page state to a client device operated by the agent. The agent device displays the web page to the agent and may store a local copy of the web page. Thus, the agent can view the state of the web page as presented to the user.

The user's client device transmits page events to the assistance server as the user interacts with the web page on the user client device. A page event describes a change made to the state of the user's web page. The change described by a page event can be caused by the user or by the user client device. For example, a page event can describe a mouse click by the user, an option selected by the user, text input by a user, or updates to displayed information made by the user client device. The assistance server stores the page event and transmits the page event to the agent device. The agent device can then apply the page event to the displayed web page.

The agent can also make changes to the user's web page via the agent's device. To change the user's web page, the agent device transmits an event request to the user's client device. The user's client device determines whether to confirm the agent's event request. For example, the user client device may prompt the user to confirm the agent's event request or may determine whether the user's event request conflicts with an event caused by the user. If the user's client device confirms the event request, the user's client device transmits an event confirmation to the assistance server. The assistance server stores the confirmed event and transmits the event confirmation to the agent device.

The assistance server can replay a user's session to a viewer based on stored web page states and page events. The viewer of the replayed session can be the user, the agent, an individual associated with the online system, or an individual associated with a third-party system. The assistance server can display the original state of a web page to the viewer and applies changes in the stored events to the web page over time based on timestamps associated with the stored events. The assistance server can also transmit audio data associated with the session to the viewer to be replayed with the displayed web page.

The online system described herein improves on conventional technology by allowing an agent of the online system to associate an out-of-band channel with a session established between the user and the agent. Additionally, by conveying the state of the user's web page using page events rather than a video stream of a screen capture from the user's client device, the online system reduces the amount of bandwidth necessary to establish and maintain the session and reduces the amount of storage needed to store the session for later playback. Finally, the replay of the session is improved because the recreation of the session allows a viewer of the recreation to view different portions of the web page from the user's view or the agent's view during the session.

### BRIEF DESCRIPTION OF THE DRAWINGS

FIG. 1 illustrates an example system environment and architecture for an online system, in accordance with some embodiments.

FIG. 2 is a sequence diagram for a method of establishing a web page session between a user and an agent, in accordance with some embodiments.

FIG. 3 is a sequence diagram illustrating the operation of an event-based session, in accordance with some embodiments.

FIG. 4 is a flowchart illustrating a method for recreating an event-based session, in accordance with some embodiments.

FIG. 5 illustrates an example web page, in accordance with some embodiments.

FIG. 6 illustrates an example session identifier presented to a user, in accordance with some embodiments.

FIG. 7 illustrates an example web page presented to a user wherein an agent can provide assistance to the user, in accordance with some embodiments.

FIG. 8 illustrates a user interface for replaying a session to a viewer, in accordance with some embodiments.

### DETAILED DESCRIPTION

### Example System Environment and Architecture

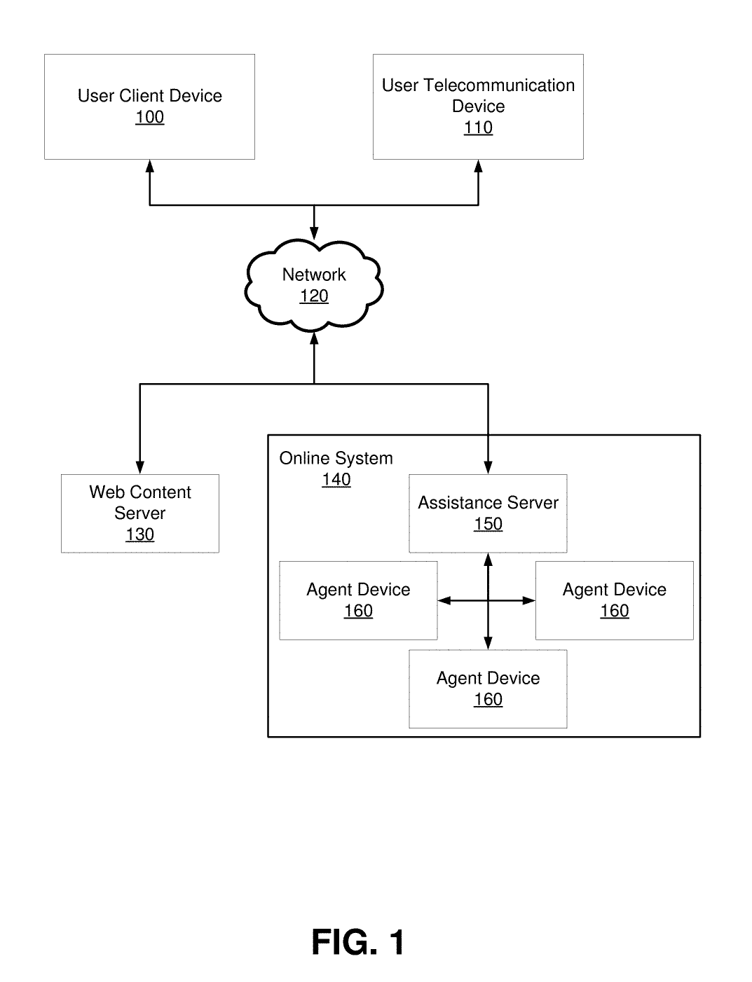

FIG. 1 illustrates an example system environment for an online system 140, in accordance with some embodiments. The system environment illustrated in FIG. 1 includes a user client device 100, a user telecommunication device 110, a network 120, a web content server 130, and an online system 140. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

The user client device 100 is a personal computing device operated by a user of the online system 140 to interact with web pages offered by the online system 140. For example, the user client device 100 can include a desktop, a laptop, a smart phone, or a tablet. The user client device 100 includes a network interface that allows the user client device 100 to communicate with the online system 140 via the network 120 and a user interface that allows the user to interact with a web page. A user can use the user client device 100 to interact with a web page and to request assistance from the online system 140. For example, the user can use the user interface of the user client device 100 to interact with elements of a web page or to select an option to request assistance from an agent of the online system 140.

The user telecommunication device 110 is a personal communication device operated by the user of the online system 140 to communicate with an agent operating an agent device 160 via an out-of-band channel. The out-of-band channel can include an audio channel (e.g., a telephone call or an internet-based voice call) or a text-based channel (e.g., a text-based chat). The user telecommunication device 110 can include a landline phone, a mobile phone, a tablet, a desktop, or a laptop. The user telecommunication device 110 includes an audio interface that receives and outputs audio information for the user and a network interface that allows the user telecommunication device 110 to communicate with an agent of the online system 140 via the network 120. While the user telecommunication device 110 is primarily described herein as a separate device from the user client device 100, the user telecommunication device 110 may be the same device as the user client device 100.

The user client device 100 and the user telecommunication device 110 can communicate with the online system 140 via the network 120. While the network 120 is primarily described herein as one network, the network 120 may include multiple networks, and the user client device 100 and the user telecommunication device 110 may communicate via different networks of the networks that make up the network 120. The network may comprise any combination of local area and wide area networks employing wired or wireless communication links. In some embodiments, the network 120 uses standard communications technologies and protocols. For example, the network 120 includes communication links using technologies such as Ethernet, 802.11, worldwide interoperability for microwave access (WiMAX), 3G, 4G, code division multiple access (CDMA), digital subscriber line (DSL), cellular networks, landline networks, etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), file transfer protocol (FTP), and voice over internet protocol (VOIP). Data exchanged over the network 120 may be represented using any format, such as hypertext markup language (HTML) or extensible markup language (XML). In some embodiments, all or some of the communication links of the network 120 may be encrypted.

The web content server 130 includes one or more servers that serve web-related content to the user client device 100, such as web page files (e.g., HTML), markup language files (e.g., XML), style sheet language files (e.g., CSS), audio files, image files, or video files. Additionally, the web content server 130 may provide application programming interface (API) functionality to send data directly to native client device operating systems, such as IOS®, ANDROID™, macOS®, OS X®, Microsoft Windows, or Linux. The web content server 130 stores one or more web pages that are available to the user operating the user client device 100. Each web page includes one or more elements with which a user can interact. Elements of pages can include text boxes, radio options, checkboxes, dropdown menus, buttons, or scroll bars. In the embodiment illustrated in FIG. 1, the web content server 130 is separate from the online system 140, however the web content server 130 can be part of the online system 140 in alternate embodiments.

FIG. 1 illustrates an example system architecture of an online system 140, in accordance with some embodiments. The online system 140 illustrated in FIG. 1 includes an assistance server 150 and one or more agent devices 160. Alternate embodiments may include more, fewer, or different components from those illustrated in FIG. 1, and the functionality of each component may be divided between the components differently from the description below. Additionally, each component may perform their respective functionalities in response to a request from a human, or automatically without human intervention.

The assistance server 150 includes one or more servers that link the online system 140 via the network 120 to the user client device 100. The web server 150 may also receive and route audio data between the online system 140 and the user telecommunication device 110.

The assistance server 150 can communicate with one or more agent devices 160 operated by agents of the online system 140. Each agent device 160 is one or more devices that an agent uses to connect to a user's session. The agent can also use an agent device 160 to establish an out-of-band channel with the user telecommunication device 110, thereby allowing the agent to communicate with the user via the out-of-band channel. An agent device 160 can include a desktop computer, a laptop computer, a landline phone, a smart phone, or a tablet.

In the embodiment illustrated in FIG. 1, the agent devices 160 are part of the online system 140. In alternative embodiments, the agent devices 160 are operated by agents of a third-party system. The third-party system may use the online system 140 to establish sessions between the agents of the third-party system and users of the third-party system. The third-party system can be a system that operates the web content server 130.

### Establishing an Web Page Session

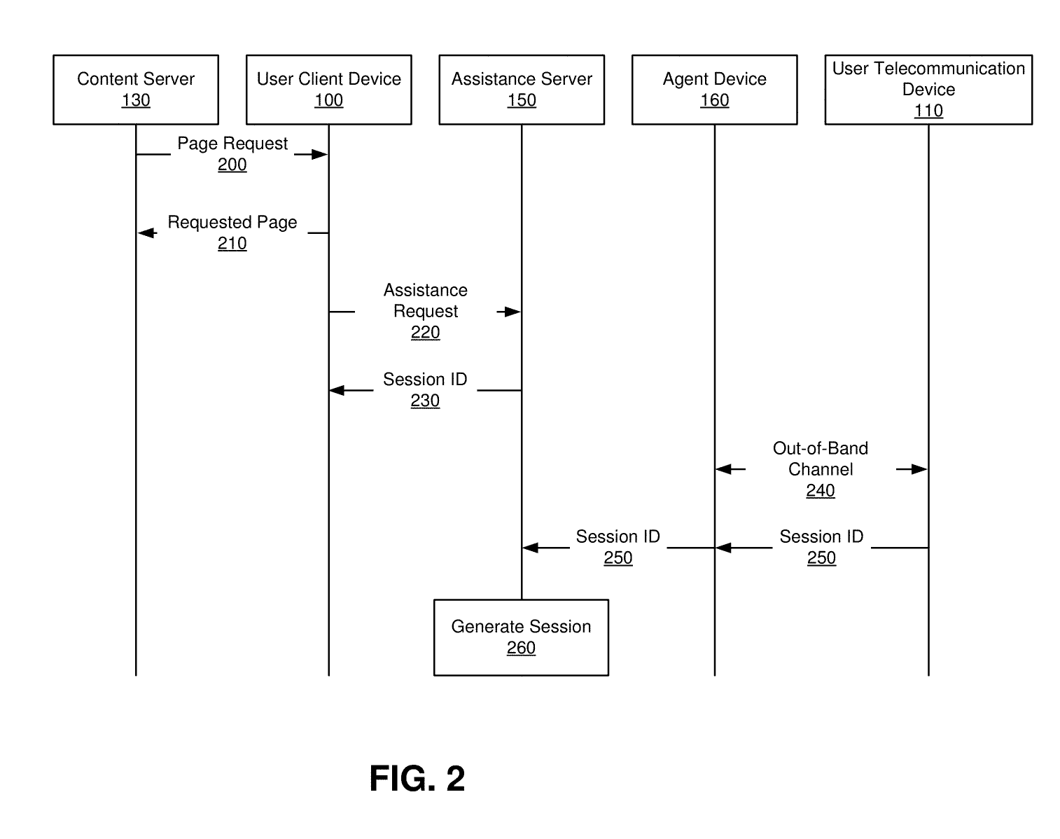

FIG. 2 is a sequence diagram for a method of establishing a web page session between a user and an agent, in accordance with some embodiments. Alternate embodiments may include more, fewer, or different steps or devices from those illustrated in FIG. 2, and the steps may be performed in a different order from that illustrated in FIG. 2. Additionally, each of these steps may be performed automatically by the user client device 100, the user telecommunication device 110, the web content server 130, the assistance server 150, or the agent device 160 without human intervention.

The user client device 100 transmits a request 200 for a web page to the web content server 130. The web page request 200 can include an identifier for a web page or an internet address for the web page. The web content server 130 transmits the requested web page 210 to the user client device 100 for display to the user. The requested web page 200 includes an element that allows the user to request assistance from an agent of the online system 140. If the user selects the element, the user client device 100 transmits an assistance request 220 to the assistance server 150. In some embodiments, the user client device 100 transmits the assistance request 220 to the assistance server 150 automatically without input from the user. For example, the user client device 100 may automatically send the assistance request 220 in an attempt to reconnect to the assistance server 150 in the event that the connection is dropped. The assistance request 220 can include a user identifier for the user, a page identifier for the web page the user is viewing, or a current state of the web page. The assistance server 150 replies to the assistance request 220 by transmitting a session identifier 230 to the user client device 100. The session identifier is a unique identifier for the session to be used by the user and the agent.

To communicate the session identifier to the agent, the user telecommunication device 110 establishes an out-of-band channel 240 with the agent device. The out-of-band channel 240 can include a phone call via a telephone network or an online audio communication service, video chat using a video chat service, or a text-based chat using a text-based chat service. The assistance server 150 can store audio data, video data, or text data that is transmitted as a part of the out-of-band channel 240 between the user telecommunication device 110 and the agent device 160. The channel data is stored with timestamps that indicate when the channel data is recorded. In some embodiments, the agent device 160 transmits the channel data to the assistance server 150 for storage during or after the out-of-band channel use. Alternatively, the out-of-band channel may be established with the agent device 160 via the assistance server 150, and the assistance server 150 automatically stores the channel data as the channel data is transmitted via the out-of-band channel 240.

The user communicates the session identifier 250 to the agent device 160 via the out-of-band channel 240. The agent device 160 subsequently transmits the session identifier 250 to the assistance server 150. In some embodiments, the agent manually inputs the session identifier 250 into the agent device 160 for transmission to the assistance server 150. Alternatively, the agent device 160 may be automatically configured to receive the session identifier 250 from the user and transmit the session identifier 160 to the assistance server 150 (e.g., via voice recognition or through dial input from a telephone).

The assistance server 150 uses the session identifier 250 to generate 260 the session between the user and the agent. The assistance server 150 can match the session identifier 250 received from the agent device 160 with the session identifier 230 transmitted to the user client device 100 to ensure that the session is generated between the correct agent device 160 and user client device 100. In some embodiments, the assistance server 150 automatically generates 260 the session in response to receiving a session identifier from the agent device 160, with or without receiving an assistance request 220 from the user client device 100.

In some embodiments, as part of generating 260 the session or after the session has begun, the assistance server 150 stores elements of the web page. Some web pages contain links to elements stored in locations different from where the web page is stored, and the web page is generated for the user by pulling the elements from their linked locations. The assistance server 150 can locally store the elements of a web page such that, if the elements to which the page links are directed change, the assistance server 150 can still recreate the web page as viewed during the session based on the stored elements of the original web page. For example, the assistance server 150 may store images presented on a web page to ensure that a replay of a session involving the web page displays the original images displayed on the web page should the images on the web page change in the future. The assistance server 150 also stores other files associated with the web page that impact how the web page is displayed, such as markup language files or style sheet language files. In some embodiments, the assistance server 150 or the user client device 100 edits page links of the stored web page to reference the location of the stored elements rather than the original location of the elements.

### Operation of an Event-Based Session

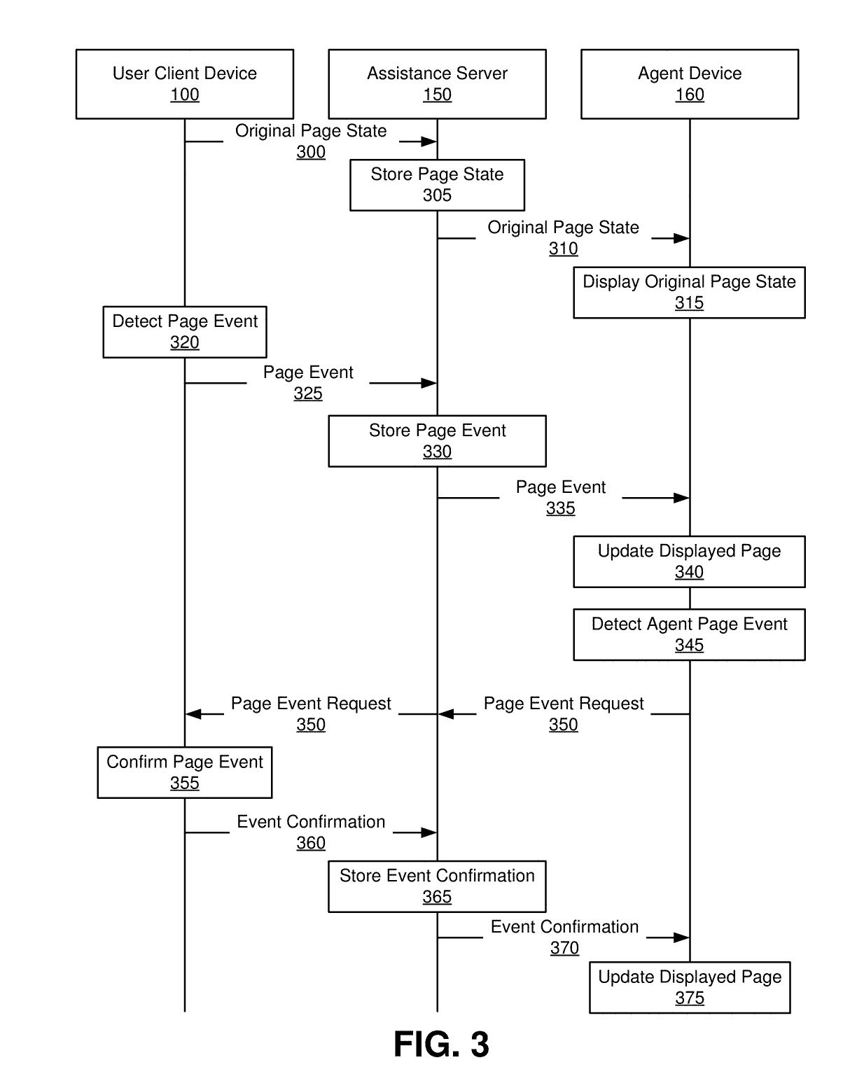

FIG. 3 is a sequence diagram illustrating the operation of an event-based session, in accordance with some embodiments. Alternate embodiments may include more, fewer, or different steps or devices from those illustrated in FIG. 3, and the steps may be performed in a different order from that illustrated in FIG. 3. Additionally, each of these steps may be performed automatically by the user client device 100, the assistance server 150, or the agent device 160 without human intervention.

The user client device 100 transmits an original state of the web page 300 to the assistance server 150. The original page state 300 describes the state of the web page when the user requested assistance from the online system 140. The original page state 300 can include an identifier for the web page that the user is viewing and information describing interactions that the user has had with the web page. The original page state 300 can also indicate a portion of the web page that the user is currently viewing, the current location of a mouse cursor on the web page, or the current location of a typing cursor on the web page. The assistance server 150 receives the original page state 300 from the user client device 100 and stores 305 the original page state. In some embodiments, the assistance server 150 stores 305 the original page state with a timestamp indicating when the original page state was received or stored. The assistance server 150 transmits the original page state 310 to the agent device 160 and the agent device 160 displays 315 the web page to the agent according to the original page state 310. In some embodiments, the agent device 160 stores a local copy of the web page and presents the local copy of the web page to the agent.

The online system 140 uses page events detected on the user client device 100 to update the assistance server 150 and the agent device 160 with the current state of the web page. Page events describe changes made to the state of the web page made by the user or the user client device 100. Page events can describe edits made to the web page, such as the selection of an option or text input by the user into a text field, as well as additional elements added to or removed from the page. Page events can also describe a user's interactions with the user client device 100, such as an adjustment to the user's view of the web page, a movement of a mouse cursor, a press of a keyboard button, or a tap on a touch screen display. A page event can include a type of the page event, values associated with the page event (such as text that was input to a text field, a new location of a mouse cursor, or the new boundaries of the user's view of the web page), changes to the content or the layout of the web page, or an element identifier for an element associated with the page event.

The user client device 100 creates or detects 320 page events associated with the web page and transmits the detected page events 325 to the assistance server 150. The assistance server 150 stores 330 the page events 325 and transmits the page event 335 to the agent device 160. The agent device 160 updates 340 the state of the web page displayed to the agent based on the received page event and, in some embodiments, updates a local copy of the web page.

The agent can use the agent device 160 to make changes to the user's web page. If the agent interacts with the web page, the agent device 160 detects 345 the agent page event and transmits a page event request 350 to the user client device 100 via the assistance server 150. The page event request 350 describes a page event to be executed on the web page. The page event request can describe a change to be made to the web page, a page event type, or a value associated with the page event. In some embodiments, the assistance server 150 stores the page event request 350 along with a timestamp of when the agent device 160 transmitted the page event request or when the assistance server 130 stored the page event request.

In response to receiving the page event request 350 from the agent device 160, the user client device 100 determines whether to confirm 355 the page event request. In some embodiments, the user client device 100 determines whether to confirm the page event request based on whether the requested page event conflicts with another page event already performed by the user via the user client device 100, thereby ensuring the accuracy of the versions of the web page presented to the user and to the agent. For example, if the page event request describes an event that selects an option on the web page and the user has already selected the option on the web page or a conflicting option on the web page, the user client device 100 may deny the page event request. Additionally, the user client device 100 may deny the page event request if the user has indicated that they do not want the agent to be able to interact with the web page. In some embodiments, the user client device 100 can lock an element of the web page when the user interacts with the element and deny page event requests relating to the element until the user has unlocked the element. For example, if the user is typing in a text field element, the user client device 100 may lock the text field element until the user has finished typing. The user client device 100 can unlock an element in response to the user interacting with a different element or in response to receiving an instruction from the user to unlock the element.

If the user client device 100 confirms 355 the page event, the user client device 100 applies the page event to the web page and transmits an event confirmation 360 to the assistance server 150 that acknowledges that the page event has been applied to the user's state of the web page. Alternately, rather than sending an explicit event confirmation 360 to the assistance server 150, the user client device 100 implicitly confirms the page event by transmitting the current state of the web page to the assistance server 150. In some embodiments, the user client device 100 locks an element associated with the page event request and prevents the user from interacting with the element until the agent has finished interacting with the element. The assistance server 150 stores 365 the event confirmation 360 with a timestamp that describes when the assistance server 150 received the event confirmation and transmits the event confirmation 370 to the agent device 160. Upon receiving the event confirmation 370, the agent device 160 updates 375 the web page displayed to the agent to reflect the requested page event. In some embodiments, the agent device 160 does not update the displayed web page until receiving the event confirmation 165 and may notify the agent that confirmation of the page event request is pending. The agent device 160 also may update a stored local copy of the web page with the requested page event upon receiving the event confirmation.

Any steps described above can be repeated during the session between the user and the agent. For example, the user client device 100 may regularly transmit the current state of the web page to the agent device 160 via the assistance server 150 so that the agent device 160 remains up-to-date with the actual current state of the web page. Similarly, more than one page event can be transmitted to the agent device 160 and the agent device 160 can apply the page events in the order in which they are transmitted.

### Recreating a Session

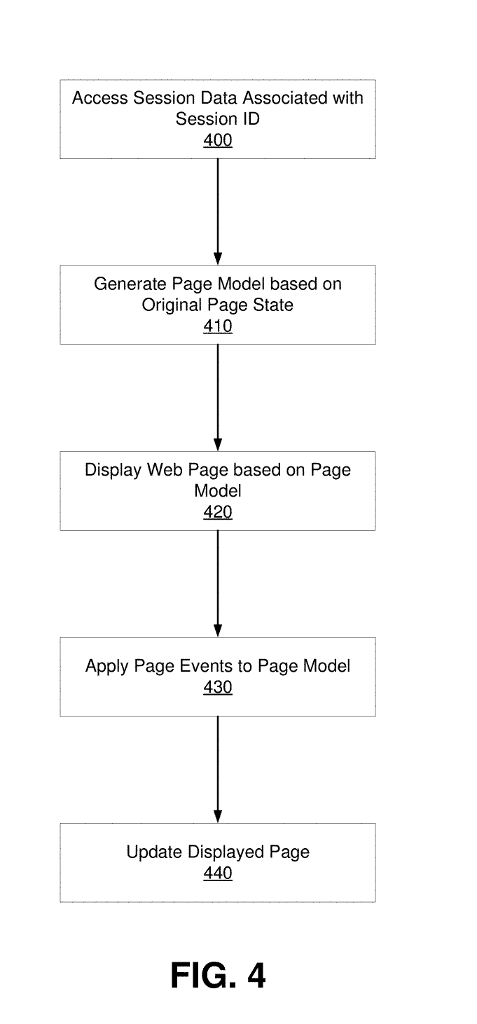

FIG. 4 is a flowchart illustrating a method for recreating an event-based session, in accordance with some embodiments. Alternate embodiments may include more, fewer, or different steps from those illustrated in FIG. 4, and the steps may be performed in a different order from that illustrated in FIG. 4. Additionally, each of these steps may be performed automatically by the assistance server 150 without human intervention.

The assistance server 150 can recreate a session between a user and an agent by reapplying the page events to the original state of the web page, thereby allowing a viewer to replay and review the session. The viewer can be the user, the agent, or another individual associated with the online system 140. The assistance server 150 accesses 400 session data associated with a session identifier. Session data includes data stored by the assistance server 150 from a session, such as states of the web page, page events, page event requests, event confirmations, stored page elements, or channel data from an out-of-band channel between the agent device 160 and the user telecommunication device 110. In some embodiments, the assistance server 150 accesses the session data associated with a session in response to receiving a session identifier from a user or an agent of the online system 140.

The assistance server 150 generates 410 an initial model of the web page based on the accessed session data and displays 420 a recreation of the web page from the session based on the web page model. In some embodiments, the assistance server 150 uses the original state of the web page to generate the initial model of the web page. The assistance server 150 recreates the session by applying 430, to the page model, the page events that were applied to the original web page. The assistance server 150 can use stored timestamps associated with the page events to recreate the page events applied to the web page at times corresponding to when the original page events occurred. In some embodiments, the assistance server 150 accesses a series of page events that are arranged in the series based on time stamps associated with the page events. The assistance server 150 can apply the page events to the page model based on their order in the series.

The assistance server 150 updates 440 the displayed web page based on the page events applied to the page model to reflect the page events that occurred during the session. In some embodiments, the assistance server 150 recreates the page model based on stored states of the web page that were transmitted by the user client device 100 after the original web page state was transmitted by the user client device 100. For example, the assistance server 150 may generate a new page model based on subsequent web page states transmitted by the user client device 100 during the session.

### Example User Interfaces

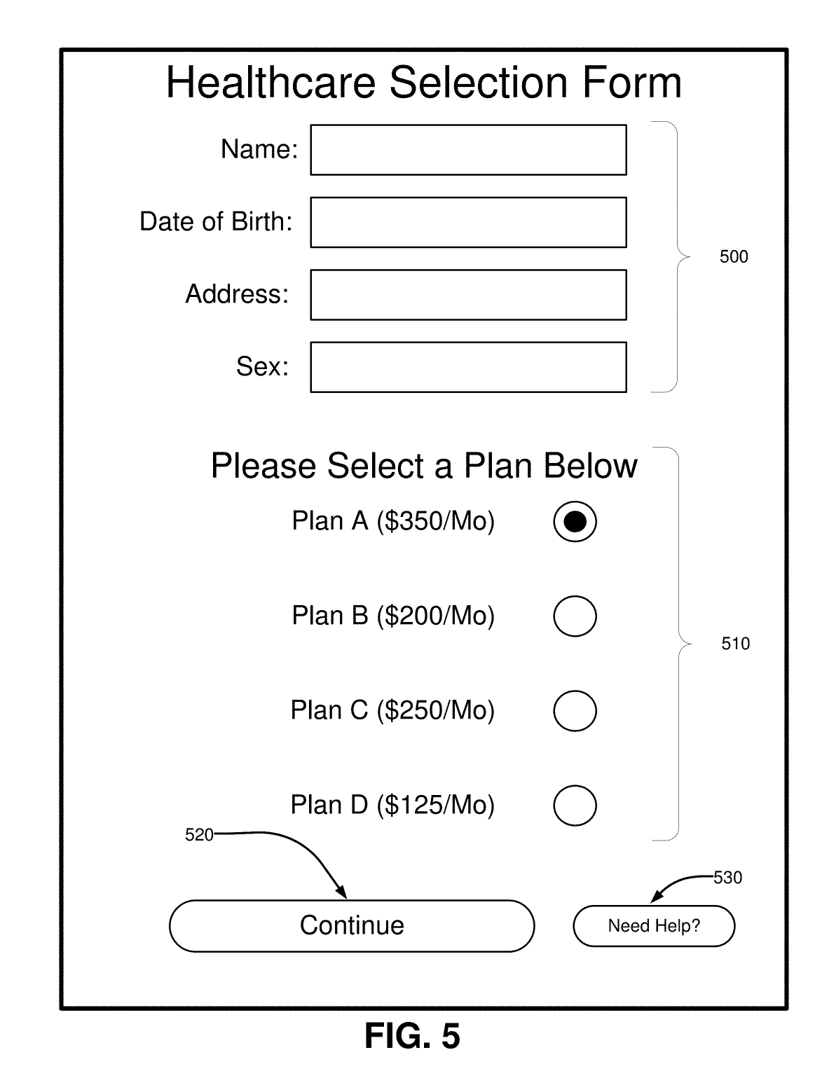

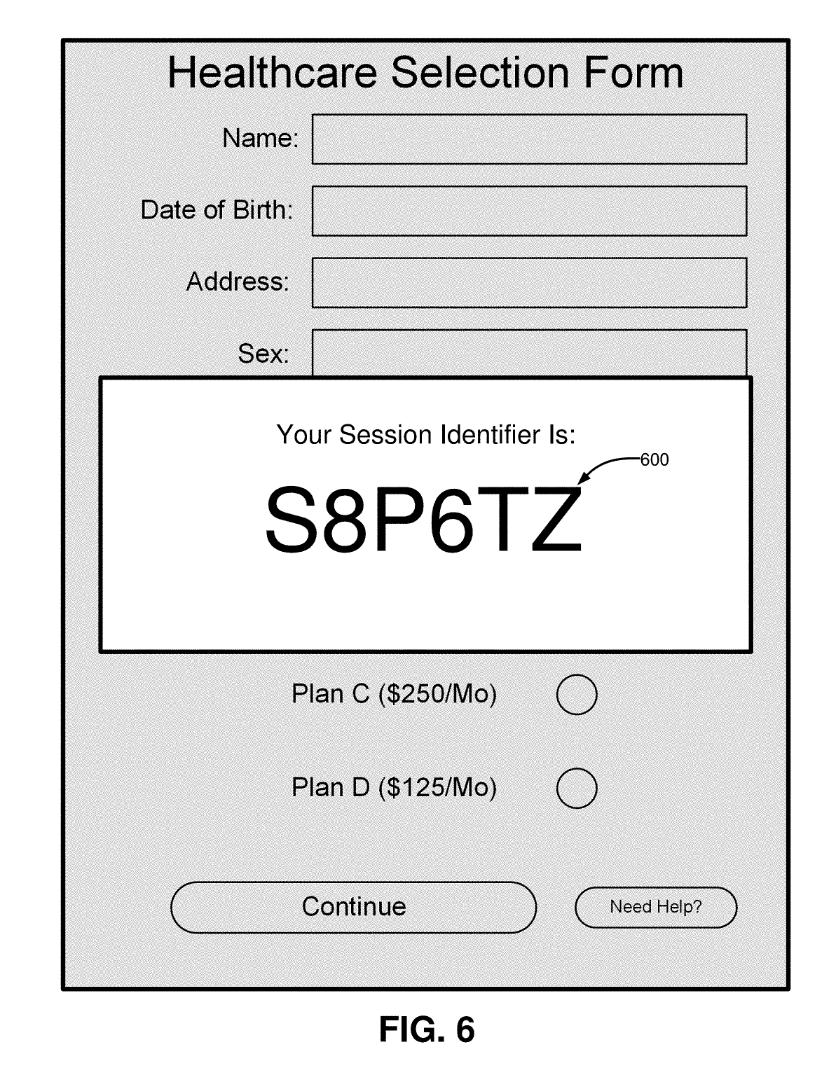

FIG. 5 illustrates an example web page, in accordance with some embodiments. The web page illustrated in FIG. 5 includes web page elements, such as text field elements 500 and option selection elements 510. The web page also includes a link element 520 to transfer to another web page. A user can view and interact with the web page using the user client device 100 and, if the user needs assistance from an agent, the user can select an assistance request element 530. The user client device 100 transmits an assistance request to the assistance server 150 and the assistance server 150 transmits a session identifier to the user client device 100 to be presented to the user. FIG. 6 illustrates an example session identifier 600 presented to a user, in accordance with some embodiments.

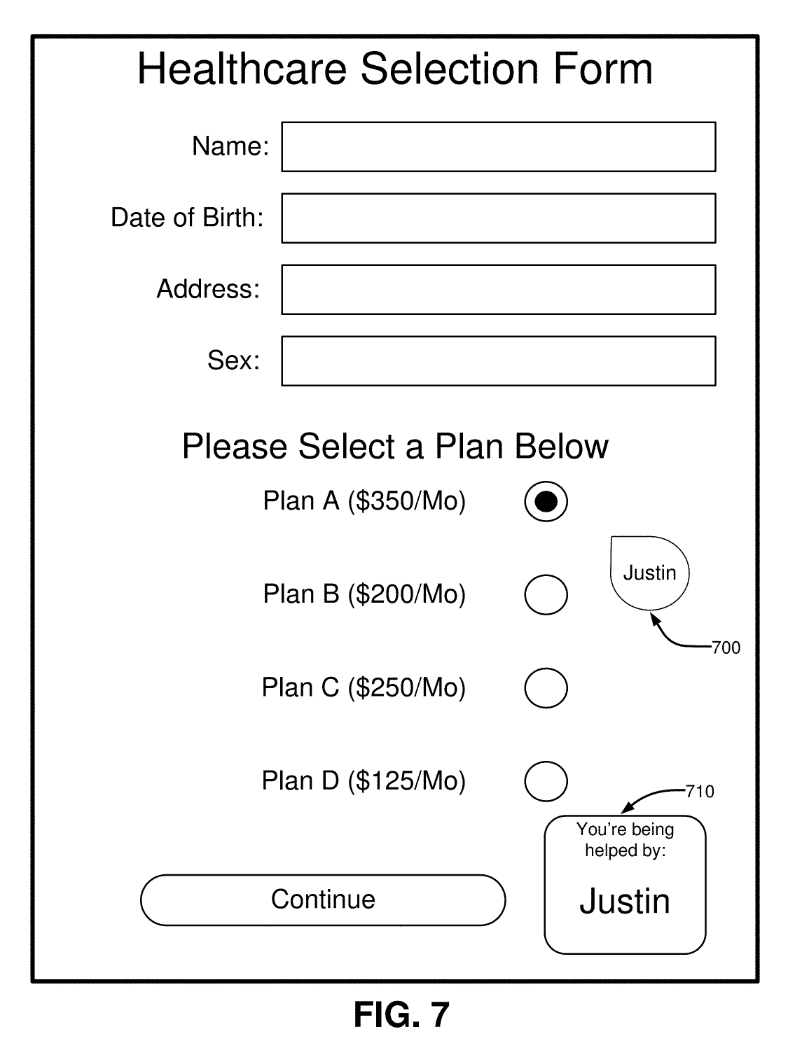

FIG. 7 illustrates an example web page presented to a user wherein an agent can provide assistance to the user, in accordance with some embodiments. The agent has received the session identifier from the user via an out-of-band channel established between the user telecommunication device 110 and the agent device 160. The example web page includes an indicator 700 of the location of the agent's mouse on the web page and an identifier 710 for the agent.

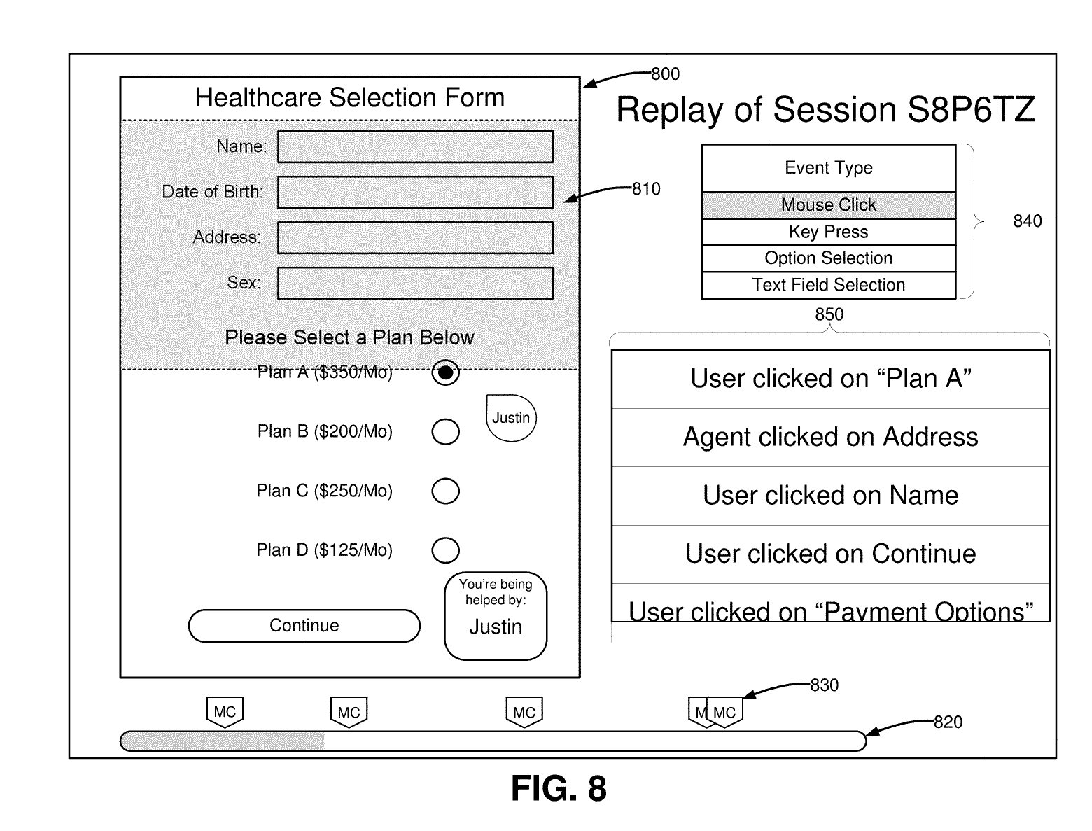

FIG. 8 illustrates a user interface for replaying a session to a viewer, in accordance with some embodiments. The user interface includes a displayed web page 800 reflecting a web page model generated from stored web page states and stored page events. The user interface also includes an indicator 810 of the portion of the web page viewed by the user or the agent during the session. The user interface may also include an indication of the location of the user's mouse, the agent's mouse, the user's keyboard cursor, or the agent's keyboard cursor.

The user interface includes a scrubber 820 that a viewer can select a time during the session to go to and watch a recreation of the session from that time forward. Audio channel data associated with the session can be replayed and synchronized with the replay of the session. The scrubber includes one or more event indicators 830 that describe where in the session's timeline page events occurred and can indicate a type of the page events. The viewer can select options 840 for which event types the viewer would like to see on the scrubber. The selected options can also be used to determine which events are listed in a list of events 850 included in the user interface. The viewer can select the event indicators 830 or the listed events 850 to skip to the point in the session timeline when the event occurred and replay the session from that point.

In some embodiments, the user interface includes a search field wherein a viewer of the replayed session can search for page events within the session. The viewer can input one or more keywords into the search field and the user interface can display page events that correspond to the keywords. Page events that correspond to the keywords can include page events that add text to the web page that contains the keyword or page events that relate to elements of the web page associated with the keywords. In some embodiments, the page events are presented via indicators 830 on the scrubber 820 or in a list presented on the user interface.

The viewer can also use the search field to search a transcript of a communication captured in audio data associated with the session. The user interface can present indicators on the scrubber 820 corresponding to times during the session when the user or the agent said a keyword. The viewer can select an indicator to replay the session beginning at the time when the user or agent said the keyword.

### Additional Configurations

While the description above may focus on event-based sessions relating to web pages, the principles herein can be applied to other contexts than web pages displayed to a user. The user can request assistance from the online system for any user interface page (or “page”) displayed to the user. A user interface page is a user interface presented to the user by the user client device. For example, a user interface page can include a web page displayed via a web browser, as described above, or a layout view that is part of a user interface for a client application operating on the user client device. User interface pages may be transmitted to the user client device by the web content server or may be generated and stored locally on the user client device and are presented to the user as the user progresses through the client application. As described above, the user can request assistance from the online system via an element of the user interface page and can establish a session between the web server and the user client device, as described above.

The user client device can transmit the state of the user interface page to the online system. The state of the user interface page can include the state of a web page presented to the user or the state of a user interface associated with a client application operating on the user client device. When the state of the user interface page changes (e.g., in response to a user's interaction with the user interface page), the user client device can transmit a page event to the web server describing the change to the page state, as described above. Additionally, the agent device can transmit page event requests to the user client device to cause changes to the state of the user interface page on the user client device.

### Additional Considerations

The foregoing description of the embodiments has been presented for the purpose of illustration; it is not intended to be exhaustive or to limit the patent rights to the precise pages disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, an assistance request from a user client device, wherein the assistance request identifies a page with which a user operating the user client device needs assistance;
responsive to receiving the assistance request, generating a session identifier for a session associated with the user, wherein the session allows an agent of the online system to provide assistance to the user;
transmitting the session identifier to the user client device;
receiving the session identifier at an agent device operated by an agent, wherein the session identifier is received via an out-of-band channel; and
responsive to receiving the session identifier via the out-of-band channel, generating a session between the user and the agent.

2. The method of claim 1, further comprising:
transmitting the page to the user client device.

3. The method of claim 1, wherein the assistance request comprises an original state of the page, and wherein the original state of the page describes one or more changes made to the page before the session is generated.

4. The method of claim 3, wherein the page comprises a plurality of page elements, and wherein the one or more changes are associated with one or more of the plurality of page elements.

5. The method of claim 4, wherein generating a session between the user and the agent comprises:
storing the plurality of page elements at the online system, wherein the plurality of page elements are stored in association with the session identifier.

6. The method of claim 1, wherein the session identifier is received from a user telecommunication device, wherein the user telecommunication device is a different device than the user client device.

7. The method of claim 1, wherein generating the session comprises:
matching a received session identifier from the with the session identifier transmitted to the user client device.

8. The method of claim 1, wherein the out-of-band channel comprises an audio channel between the user and the agent.

9. The method of claim 1, further comprising:
storing audio data transmitted via the out-of-band channel.

10. The method of claim 1, wherein the page is a web page or a user interface layout view of a client application.

11. A computer-readable medium comprising instructions that, when executed by a processor, cause the processor to:
receive, at an online system, an assistance request from a user client device, wherein the assistance request identifies a page with which a user operating the user client device needs assistance;
responsive to receiving the assistance request, generate a session identifier for a session associated with the user, wherein the session allows an agent of the online system to provide assistance to the user;
transmit the session identifier to the user client device;
receive the session identifier at an agent device operated by an agent, wherein the session identifier is received via an out-of-band channel; and
responsive to receiving the session identifier via the out-of-band channel, generate a session between the user and the agent.

12. The computer-readable medium of claim 11, wherein the instructions further cause the processor to:
transmit the page to the user client device.

13. The computer-readable medium of claim 11, wherein the assistance request comprises an original state of the page, and wherein the original state of the page describes one or more interactions that the user has had with the page before the session is generated.

14. The computer-readable medium of claim 13, wherein the page comprises a plurality of page elements, and wherein the one or interactions are associated with one or more of the plurality of page elements.

15. The computer-readable medium of claim 14, wherein the instructions for generating a session between the user and the agent further comprise instructions that cause the processor to:
store the plurality of page elements at the online system, wherein the plurality of page elements are stored in association with the session identifier.

16. The computer-readable medium of claim 11, wherein the session identifier is received from a user telecommunication device, wherein the user telecommunication device is a different device than the user client device.

17. The computer-readable medium of claim 11, wherein the instructions for generating the session comprises instructions that cause the processor to:
match a received session identifier from the with the session identifier transmitted to the user client device.

18. The computer-readable medium of claim 11, wherein the out-of-band channel comprises an audio channel between the user and the agent.

19. The computer-readable medium of claim 11, wherein the instructions further cause the processor to:
store audio data transmitted via the out-of-band channel.

20. The computer-readable medium of claim 11, wherein the page is a web page or a user interface layout view of a client application.
